(19) United States
(12) Patent Application Publication
(10) Pub. No.: US 2021/0011152 A1
(43) Pub. Date: Jan. 14, 2021

(54) ULTRASONIC RANGING METHOD AND APPARATUS AND ROBOT USING THE SAME

(71) Applicant: UBTECHI ROBOTICS CORP LTD, Shenzhen (CN)

(72) Inventors: Gaobo Huang, Shenzhen (CN); Bin He, Shenzhen (CN); Xiangbin Huang, Shenzhen (CN); Wenxue Xie, Shenzhen (CN); Youjun Xiong, Shenzhen (CN)

(21) Appl. No.: 16/837,980

(22) Filed: Apr. 1, 2020

(30) Foreign Application Priority Data
Jul. 11, 2019 (CN) 201910622950.0

(51) Int. Cl. G01S 15/08; G01S 15/89

(52) U.S. Cl. CPC G01S 15/08; G01S 7/52017; G01S 15/8906

(57) ABSTRACT

The present disclosure discloses an ultrasonic ranging method as well as an apparatus, and a robot using the same. The method includes: obtaining ultrasonic ranging data detected by a preset ultrasonic sensor; filtering the ultrasonic ranging data to obtain the filtered ultrasonic ranging data; determining whether a measured distance of a target sampling point meets a preset stability determination condition, where the target sampling point is any sampling point in the filtered ultrasonic ranging data; and recording and outputting the measured distance of the target sampling point, if the measured distance of the target sampling point meets the stability determination condition. According to the present disclosure, after the ultrasonic ranging data is filtered, the measured distance of each sampling point in the ultrasonic ranging data is further determined through the preset stability determination condition, which greatly reduces the probability of the occurrence of false alarms.

### CROSS REFERENCE TO RELATED APPLICATIONS

The present disclosure claims priority to Chinese Patent Application No. 201910622950.0, filed Jul. 11, 2019, which is hereby incorporated by reference herein as if set forth in its entirety.

### BACKGROUND

### 1. Technical Field

The present disclosure relates to robot technology, and particularly to an ultrasonic ranging method as well as an apparatus, and a robot using the same.

### 2. Description of Related Art

During the movement of a robot, obstacle avoidances need to be performed according to the ranging results. The sensors for ranging generally include radar, RGBD sensor, ultrasound sensor, infrared sensor, and the like. Among the above-mentioned sensors, since only the ultrasonic sensor can detect transparent obstacles such as glass, the ultrasonic sensor is a kind of sensors which are indispensable in the robot. However, ultrasonic ranging is particularly prone to false alarms. The reasons for false alarms include the structure and assembly of ultrasonic sensors, or ultrasonic interferences because of the ultrasonic waves from other equipment (e.g., other robot) nearby or the ultrasonic waves received by the receiver after multiple reflections in a specific environment. Once a false alarm occurs, the navigation behaviors of a robot will become weird. Sometimes, for the places where can be passed straightly, the incorrectly reported ultrasonic ranging result will make the robot determining that there is an obstacle in front, which will cause the robot to have weird behaviors such as unnecessary rotate, detour, stop, and the like.

### BRIEF DESCRIPTION OF THE DRAWINGS

In order to more clearly illustrate the technical solutions in the present disclosure, the drawings used in the embodiments or the description of the prior art will be briefly introduced below. It should be understood that, the drawings in the following description are only examples of the present disclosure. For those skilled in the art, other drawings can be obtained based on these drawings without creative works.

FIG. 1 is a flow chart of an embodiment of an ultrasonic ranging method according to the present disclosure.

FIG. 2 is a schematic diagram of an example of comparing an ultrasonic ranging result with radar ranging data according to an embodiment of the present disclosure.

FIG. 3 is a schematic block diagram of an embodiment of an ultrasonic ranging apparatus according to the present disclosure.

FIG. 4 is a schematic block diagram an embodiment of a robot according to the present disclosure.

### DETAILED DESCRIPTION

In order to make the objects, features and advantages of the present disclosure more obvious and easy to understand, the technical solutions in the embodiments of the present disclosure will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

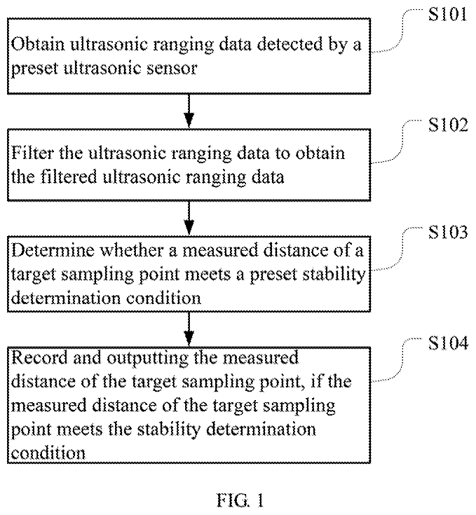

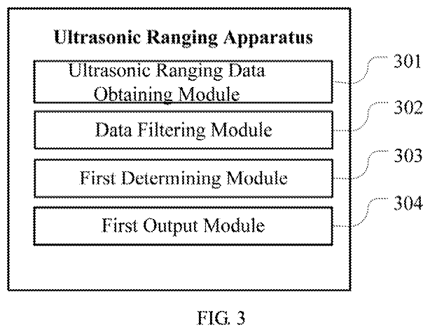

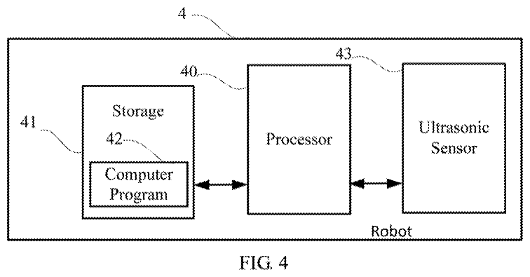

FIG. 1 is a flow chart of an embodiment of an ultrasonic ranging method according to the present disclosure. In this embodiment, an ultrasonic ranging method is provided. The method is a computer-implemented method executable for a processor, which may be implemented through and applied to an ultrasonic ranging apparatus as shown in FIG. 3 or implemented through a robot as shown in FIG. 4. As shown in FIG. 1, the method includes the following steps.

S101: obtaining ultrasonic ranging data detected by a preset ultrasonic sensor.

The ultrasonic sensor can adopt a detection mode of direct reflection type, where a detected object located in front of the sensor reflects a part of the sound waves emitted by a transmitter of the sensor back to the receiver of the sensor, so that the sensor detects the detected object. The effective ranging range of the ultrasonic sensor depends on the wavelength and frequency used. The longer the wavelength, the smaller the frequency, and the larger the effective ranging range. In this embodiment, the ultrasonic sensor with an effective ranging range of 0 to 150 cm is used. In other embodiments, other ultrasonic sensor with other effective ranging range can also be used according to the actual condition, which is not limited herein. The ultrasonic ranging data detected by the ultrasonic sensor are all values within the effective ranging range, and the data outside the effective ranging range are all set to invalid values.

S102: filtering the ultrasonic ranging data to obtain the filtered ultrasonic ranging data.

In an example, a mean deviation of each sampling point in the ultrasonic ranging data can be first calculated based on the formula of:

$$AvgDev ( n ) = abs ( Data ( n ) - \frac{{\sum }_{i = - K}^{K} Data ( n + i )}{2 K + 1} ) ;$$

where, n is a serial number of each sampling point in the ultrasonic ranging data, Data(n) is the measured distance of the n-th sampling point in the ultrasonic ranging data, K is a window length parameter of a preset filter window which can be set to 2, 3, 5, or other value according to actual conditions, abs is an absolute value function, and AvgDev(n) is the mean deviation of the n-th sampling point in the ultrasonic ranging data; and

then, the sampling points with the mean deviation larger than a preset mean deviation threshold is filtered out from the ultrasonic ranging data to obtain the filtered ultrasonic ranging data, where the mean deviation threshold can be set to 5, 10, 15, or other value according to actual conditions.

In other embodiments, a variance deviation of each sampling point in the ultrasonic ranging data is first calculated based on the formula of:

$$Var Dev ( n ) = {abs ( Data ( n ) - \frac{ {\sum }_{i = - K}^{K} Data ( n + i )}{2 K + 1} )}^{2} - \frac{{\sum }_{j = - K}^{K} {( \begin{matrix}Data ( j ) - \\ \frac{{\sum }_{i = - K}^{K} Data ( n + i )}{2 K + 1}\end{matrix} )}^{2}}{2 K + 1} ) ;$$

where, n is a serial number of each sampling point in the ultrasonic ranging data, Data(n) is the measured distance of the n-th sampling point in the ultrasonic ranging data, K is a window length parameter of a preset filter window, abs is an absolute value function, and VarDev(n) is the variance deviation of the n-th sampling point in the ultrasonic ranging data.

Then, the sampling points with the variance deviation larger than a preset variance deviation threshold is filtered out from the ultrasonic ranging data to obtain the filtered ultrasonic ranging data. The variance deviation threshold can be set to 20, 50, 100, or other value according to actual conditions.

S103: determining whether a measured distance of a target sampling point meets a preset stability determination condition.

The target sampling point is any sampling point in the filtered ultrasonic ranging data. The stability determination condition can be:

(Dis−PreDis)²<Threshold;

where, Dis is the measured distance of the target sampling point, PreDis is a measured distance of the previous sampling point of the target sampling point, and Threshold is the preset stability determination threshold which can be set to 3, 5, 10 or other value according to actual conditions.

If the measured distance of the target sampling point meets the stability determination condition, it indicates that the measured distance of the target sampling point is stable and reliable, and it can continue to execute step S104.

S104: recording and outputting the measured distance of the target sampling point, if the measured distance of the target sampling point meets the stability determination condition.

Then, the output measured distance of the target sampling point can be applied to a navigation module or other module of the robot.

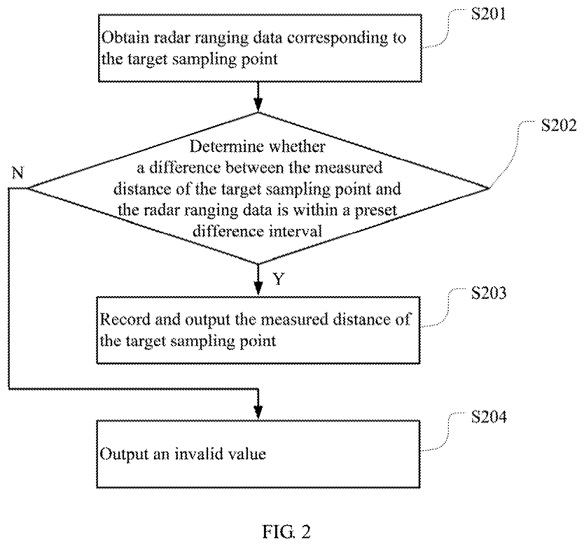

If the measured distance of the target sampling point does not meet the stability determination condition, it means that the measured distance of the target sampling point is unstable, and the measured distance can be recorded first and not output. FIG. 2 is a schematic diagram of an example of comparing an ultrasonic ranging result with radar ranging data according to an embodiment of the present disclosure. As shown in FIG. 2, the recorded measured distance (i.e., the ultrasonic ranging result) is then compared with radar ranging data of the robot through the following steps.

S201: obtaining radar ranging data corresponding to the target sampling point.

In this embodiment, the radar ranging data is obtained through a radar disposed on the robot. The radar can be controlled to detect in a target direction to obtain the radar ranging data, where the target direction is a direction corresponding to the target sampling point when ranging using the ultrasonic sensor.

S202: determining whether a difference between the measured distance of the target sampling point and the radar ranging data is within a preset difference interval.

The difference interval can be expressed as [−Val, Val], where the value of Val can be set to 3, 5, 10, or other value according to the actual condition.

If the difference is within the difference interval, it means that the obstacle has been detected by the radar near the distance of the detection of the ultrasound. At this time, the obstacle detected by the ultrasound can be considered as an effective obstacle rather than that a false alarm occurs, hence step S203 can be executed.

If the difference is not within the difference interval, it means that the obstacle has not been detected by the radar near the distance of the detection of the ultrasound. At this time, the obstacle detected by the ultrasound can be considered as an invalid obstacle, that is, a false alarm occurs, hence step S204 can be executed.

S203: recording and outputting the measured distance of the target sampling point.

S204: outputting an invalid value.

After the result is output, the output result can be applied to the navigation module or other module of the robot.

In summary, in this embodiment, it obtains ultrasonic ranging data detected by a preset ultrasonic sensor, filters the ultrasonic ranging data to obtain the filtered ultrasonic ranging data; determining whether a measured distance of a target sampling point meets a preset stability determination condition, where the target sampling point is any sampling point in the filtered ultrasonic ranging data; and records and outputs the measured distance of the target sampling point, if the measured distance of the target sampling point meets the stability determination condition. According to this embodiment, after the ultrasonic ranging data is filtered, the measured distance of each sampling point in the ultrasonic ranging data is further determined through the preset stability determination condition, and only the measured distance of the sampling points meeting the stability determination condition will be recorded and output, thereby greatly reducing the probability of the occurrence of false alarms, which reduces the weird behaviors of the robot that occur during navigations.

It should be understood that, the sequence of the serial number of the steps in the above-mentioned embodiments does not mean the execution order while the execution order of each process should be determined by its function and internal logic, which should not be taken as any limitation to the implementation process of the embodiments.

FIG. 3 is a schematic block diagram of an embodiment of an ultrasonic ranging apparatus according to the present disclosure. An ultrasonic ranging apparatus corresponding to the ultrasonic ranging method described in the above-mentioned embodiment is provided, which can be installed on a robot as shown in FIG. 4 or be the robot itself. As shown in FIG. 3, the ultrasonic ranging apparatus can include:

an ultrasonic ranging data obtaining module 301 configured to obtain ultrasonic ranging data detected by a preset ultrasonic sensor;

a data filtering module 302 configured to filter the ultrasonic ranging data to obtain the filtered ultrasonic ranging data;

a first determining module 303 configured to determine whether a measured distance of a target sampling point meets a preset stability determination condition, where the target sampling point is any sampling point in the filtered ultrasonic ranging data; and

a first output module 304 configured to record and output the measured distance of the target sampling point, if the measured distance of the target sampling point meets the stability determination condition.

In one embodiment, the first determining module 303 is configured to.

determine whether the measured distance of the target sampling point meets the stability determination condition of:

(Dis−PreDis)²<Threshold;

where, Dis is the measured distance of the target sampling point, PreDis is a measured distance of the previous sampling point of the target sampling point, and Threshold is the preset stability determination threshold.

In one embodiment, the ultrasonic ranging apparatus further includes:

a radar ranging data obtaining module configured to obtain radar ranging data corresponding to the target sampling point, if the measured distance of the target sampling point not meets the stability determination condition;

a second determining module configured to determine whether a difference between the measured distance of the target sampling point and the radar ranging data is within a preset difference interval; and

a second output module configured to record and output the measured distance of the target sampling point, if the difference is within the difference interval.

In one embodiment, the data filtering module 302 can include:

a first calculation unit configured to calculate a mean deviation of each sampling point in the ultrasonic ranging data based on the formula of:

$$AvgDev ( n ) = abs ( Data ( n ) - \frac{{\sum }_{i = - K}^{K} Data ( n + i )}{2 K + 1} ) ;$$

where, n is a serial number of each sampling point in the ultrasonic ranging data, Data(n) is the measured distance of the n-th sampling point in the ultrasonic ranging data, K is a window length parameter of a preset filter window, abs is an absolute value function, and AvgDev(n) is the mean deviation of the n-th sampling point in the ultrasonic ranging data; and

a first filtering unit configured to filter out the sampling points with the mean deviation larger than a preset mean deviation threshold from the ultrasonic ranging data to obtain the filtered ultrasonic ranging data.

In one embodiment, the data filtering module 302 can include:

a second calculation unit configured to calculate a variance deviation of each sampling point in the ultrasonic ranging data based on the formula of:

$$Var Dev ( n ) = {abs ( Data ( n ) - \frac{ {\sum }_{i = - K}^{K} Data ( n + i )}{2 K + 1} )}^{2} - \frac{{\sum }_{j = - K}^{K} {( \begin{matrix}Data ( j ) - \\ \frac{{\sum }_{i = - K}^{K} Data ( n + i )}{2 K + 1}\end{matrix} )}^{2}}{2 K + 1} ) ;$$

where, n is a serial number of each sampling point in the ultrasonic ranging data, Data(n) is the measured distance of the n-th sampling point in the ultrasonic ranging data, K is a window length parameter of a preset filter window, abs is an absolute value function, and VarDev(n) is the variance deviation of the n-th sampling point in the ultrasonic ranging data; and

a second filtering unit configured to filter out the sampling points with the variance deviation larger than a preset variance deviation threshold from the ultrasonic ranging data to obtain the filtered ultrasonic ranging data.

In this embodiment, each of the above-mentioned modules/units is implemented in the form of software, which can be computer program(s) stored in a memory of the ultrasonic ranging apparatus and executable on a processor of the ultrasonic ranging apparatus. In other embodiments, each of the above-mentioned modules/units may be implemented in the form of hardware (e.g., a circuit of the ultrasonic ranging apparatus which is coupled to the processor of the ultrasonic ranging apparatus) or a combination of hardware and software (e.g., a circuit with a single chip microcomputer).

Those skilled in the art can clearly understand that, for the convenience and brevity of description, the specific operation processes of the apparatus, modules, and units described above can refer to the corresponding processes in the foregoing method embodiments, which are not described herein.

In the above-mentioned embodiments, the description of each embodiment has its focuses, and the parts which are not described or mentioned in one embodiment may refer to the related descriptions in other embodiments.

FIG. 4 is a schematic block diagram an embodiment of a robot according to the present disclosure. For convenience of explanation, only parts related to this embodiment are shown.

As shown in FIG. 4, in this embodiment, the robot 4 includes a processor 40, a storage 41, a computer program 42 stored in the storage 41 and executable on the processor 40, and an ultrasonic sensor 43. When executing (instructions in) the computer program 42, the processor 40 implements the steps in the above-mentioned embodiments of the ultrasonic ranging method, for example, steps S101-S104 shown in FIG. 1. Alternatively, when the processor 40 executes the (instructions in) computer program 42, the functions of each module/unit in the above-mentioned device embodiments, for example, the functions of the modules 301-304 shown in FIG. 3 are implemented.

Exemplarily, the computer program 42 may be divided into one or more modules/units, and the one or more modules/units are stored in the storage 41 and executed by the processor 40 to realize the present disclosure. The one or more modules/units may be a series of computer program instruction sections capable of performing a specific function, and the instruction sections are for describing the execution process of the computer program 42 in the robot 4.

It can be understood by those skilled in the art that FIG. 4 is merely an example of the robot 4 and does not constitute a limitation on the robot 4, and may include more or fewer components than those shown in the figure, or a combination of some components or different components. For example, the robot 4 may further include an input/output device, a network access device, a bus, and the like.

The processor 40 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 41 may be an internal storage unit of the robot 4, for example, a hard disk or a memory of the robot 4. The storage 41 may also be an external storage device of the robot 4, for example, a plug-in hard disk, a smart media card (SMC), a secure digital (SD) card, flash card, and the like, which is equipped on the robot 4. Furthermore, the storage 41 may further include both an internal storage unit and an external storage device, of the robot 4. The storage 41 is configured to store the computer program 42 and other programs and data required by the robot 4. The storage 41 may also be used to temporarily store data that has been or will be output.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (or device)/robot and method may be implemented in other manners. For example, the above-mentioned apparatus/robot embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented ultrasonic ranging method, comprising executing on a processor steps of:
obtaining ultrasonic ranging data detected by a preset ultrasonic sensor;
filtering the ultrasonic ranging data to obtain the filtered ultrasonic ranging data;
determining whether a measured distance of a target sampling point meets a preset stability determination condition, wherein the target sampling point is any sampling point in the filtered ultrasonic ranging data; and
recording and outputting the measured distance of the target sampling point, in response to the measured distance of the target sampling point meeting the stability determination condition.

2. The method of claim 1, wherein the step of determining whether the measured distance of the target sampling point meets the preset stability determination condition comprises:
determining whether the measured distance of the target sampling point meets the stability determination condition of:
(Dis−PreDis)²<Threshold;
where, Dis is the measured distance of the target sampling point, PreDis is a measured distance of the previous sampling point of the target sampling point, and Threshold is the preset stability determination threshold.

3. The method of claim 1, further comprising:
obtaining radar ranging data corresponding to the target sampling point, in response to the measured distance of the target sampling point not meeting the stability determination condition;
determining whether a difference between the measured distance of the target sampling point and the radar ranging data is within a preset difference interval; and
recording and outputting the measured distance of the target sampling point, in response to the difference being within the difference interval.

4. The method of claim 1, wherein the step of filtering the ultrasonic ranging data to obtain the filtered ultrasonic ranging data comprises:
calculating a mean deviation of each sampling point in the ultrasonic ranging data based on the formula of:
$$AvgDev ( n ) = abs ( Data ( n ) - \frac{{\sum }_{i = - K}^{K} Data ( n + i )}{2 K + 1} ) ;$$
where, n is a serial number of each sampling point in the ultrasonic ranging data, Data(n) is the measured distance of the n-th sampling point in the ultrasonic ranging data, K is a window length parameter of a preset filter window, abs is an absolute value function, and AvgDev(n) is the mean deviation of the n-th sampling point in the ultrasonic ranging data; and
filtering out the sampling points with the mean deviation larger than a preset mean deviation threshold from the ultrasonic ranging data to obtain the filtered ultrasonic ranging data.

5. The method of claim 1, wherein the step of filtering the ultrasonic ranging data to obtain the filtered ultrasonic ranging data comprises:
calculating a variance deviation of each sampling point in the ultrasonic ranging data based on the formula of:
$$Var Dev ( n ) = {abs ( Data ( n ) - \frac{ {\sum }_{i = - K}^{K} Data ( n + i )}{2 K + 1} )}^{2} - \frac{{\sum }_{j = - K}^{K} {( \begin{matrix}Data ( j ) - \\ \frac{{\sum }_{i = - K}^{K} Data ( n + i )}{2 K + 1}\end{matrix} )}^{2}}{2 K + 1} ) ;$$
where, n is a serial number of each sampling point in the ultrasonic ranging data, Data(n) is the measured distance of the n-th sampling point in the ultrasonic ranging data, K is a window length parameter of a preset filter window, abs is an absolute value function, and VarDev(n) is the variance deviation of the n-th sampling point in the ultrasonic ranging data; and
filtering out the sampling points with the variance deviation larger than a preset variance deviation threshold from the ultrasonic ranging data to obtain the filtered ultrasonic ranging data.

6. The method of claim 1, wherein the measured distance of the target sampling point is output to a robot to navigate the robot based on the measured distance.

7. The method of claim 3, further comprising:
outputting an invalid value, in response to the difference being not within the difference interval.

8. An ultrasonic ranging apparatus, comprising:
an ultrasonic ranging data obtaining module configured to obtain ultrasonic ranging data detected by a preset ultrasonic sensor,
a data filtering module configured to filter the ultrasonic ranging data to obtain the filtered ultrasonic ranging data;
a first determining module configured to determine whether a measured distance of a target sampling point meets a preset stability determination condition, wherein the target sampling point is any sampling point in the filtered ultrasonic ranging data; and
a first output module configured to record and output the measured distance of the target sampling point, in response to the measured distance of the target sampling point meeting the stability determination condition.

9. The apparatus of claim 8, wherein the first determining module is configured to,
determine whether the measured distance of the target sampling point meets the stability determination condition of:
(Dis−PreDis)²<Threshold;
where, Dis is the measured distance of the target sampling point, PreDis is a measured distance of the previous sampling point of the target sampling point, and Threshold is the preset stability determination threshold.

10. The apparatus of claim 8, further comprising:
a radar ranging data obtaining module configured to obtain radar ranging data corresponding to the target sampling point, in response to the measured distance of the target sampling point not meeting the stability determination condition;
a second determining module configured to determine whether a difference between the measured distance of the target sampling point and the radar ranging data is within a preset difference interval; and
a second output module configured to record and output the measured distance of the target sampling point, in response to the difference being within the difference interval.

11. The apparatus of claim 8, wherein the data filtering module comprises:
a first calculation unit configured to calculate a mean deviation of each sampling point in the ultrasonic ranging data based on the formula of:
$$AvgDev ( n ) = abs ( Data ( n ) - \frac{{\sum }_{i = - K}^{K} Data ( n + i )}{2 K + 1} ) ;$$
where, n is a serial number of each sampling point in the ultrasonic ranging data, Data(n) is the measured distance of the n-th sampling point in the ultrasonic ranging data, K is a window length parameter of a preset filter window, abs is an absolute value function, and AvgDev(n) is the mean deviation of the n-th sampling point in the ultrasonic ranging data; and
a first filtering unit configured to filter out the sampling points with the mean deviation larger than a preset mean deviation threshold from the ultrasonic ranging data to obtain the filtered ultrasonic ranging data.

12. The apparatus of claim 8, wherein the data filtering module comprises:
a second calculation unit configured to calculate a variance deviation of each sampling point in the ultrasonic ranging data based on the formula of:
$$Var Dev ( n ) = {abs ( Data ( n ) - \frac{ {\sum }_{i = - K}^{K} Data ( n + i )}{2 K + 1} )}^{2} - \frac{{\sum }_{j = - K}^{K} {( \begin{matrix}Data ( j ) - \\ \frac{{\sum }_{i = - K}^{K} Data ( n + i )}{2 K + 1}\end{matrix} )}^{2}}{2 K + 1} ) ;$$
where, n is a serial number of each sampling point in the ultrasonic ranging data, Data(n) is the measured distance of the n-th sampling point in the ultrasonic ranging data, K is a window length parameter of a preset filter window, abs is an absolute value function, and VarDev(n) is the variance deviation of the n-th sampling point in the ultrasonic ranging data; and
a second filtering unit configured to filter out the sampling points with the variance deviation larger than a preset variance deviation threshold from the ultrasonic ranging data to obtain the filtered ultrasonic ranging data.

13. A biped robot comprising:
a memory; and
a processor;
wherein the memory stores a computer program executable on the processor, and the computer program comprises:
instructions for obtaining ultrasonic ranging data detected by a preset ultrasonic sensor;
instructions for filtering the ultrasonic ranging data to obtain the filtered ultrasonic ranging data;
instructions for determining whether a measured distance of a target sampling point meets a preset stability determination condition, wherein the target sampling point is any sampling point in the filtered ultrasonic ranging data; and
instructions for recording and outputting the measured distance of the target sampling point, in response to the measured distance of the target sampling point meeting the stability determination condition.

14. The robot of claim 13, wherein the instructions for determining whether the measured distance of the target sampling point meets the preset stability determination condition comprise:
instructions for determining whether the measured distance of the target sampling point meets the stability determination condition of:
(Dis−PreDis)²<Threshold;
where, Dis is the measured distance of the target sampling point, PreDis is a measured distance of the previous sampling point of the target sampling point, and Threshold is the preset stability determination threshold.

15. The robot of claim 13, wherein the computer program further comprises:
instructions for obtaining radar ranging data corresponding to the target sampling point, in response to the measured distance of the target sampling point not meeting the stability determination condition;
instructions for determining whether a difference between the measured distance of the target sampling point and the radar ranging data is within a preset difference interval; and
instructions for recording and outputting the measured distance of the target sampling point, in response to the difference being within the difference interval.

16. The robot of claim 13, wherein the instructions for filtering the ultrasonic ranging data to obtain the filtered ultrasonic ranging data comprise:
instructions for calculating a mean deviation of each sampling point in the ultrasonic ranging data based on the formula of:
$$AvgDev ( n ) = abs ( Data ( n ) - \frac{{\sum }_{i = - K}^{K} Data ( n + i )}{2 K + 1} ) ;$$
where, n is a serial number of each sampling point in the ultrasonic ranging data, Data(n) is the measured distance of the n-th sampling point in the ultrasonic ranging data K is a window length parameter of a preset filter window, abs is an absolute value function, and AvgDev(n) is the mean deviation of the n-th sampling point in the ultrasonic ranging data; and
instructions for filtering out the sampling points with the mean deviation larger than a preset mean deviation threshold from the ultrasonic ranging data to obtain the filtered ultrasonic ranging data.

17. The robot of claim 13, wherein the instructions for filtering the ultrasonic ranging data to obtain the filtered ultrasonic ranging data comprise:
instructions for calculating a variance deviation of each sampling point in the ultrasonic ranging data based on the formula of:
$$Var Dev ( n ) = {abs ( Data ( n ) - \frac{ {\sum }_{i = - K}^{K} Data ( n + i )}{2 K + 1} )}^{2} - \frac{{\sum }_{j = - K}^{K} {( \begin{matrix}Data ( j ) - \\ \frac{{\sum }_{i = - K}^{K} Data ( n + i )}{2 K + 1}\end{matrix} )}^{2}}{2 K + 1} ) ;$$
where, n is a serial number of each sampling point in the ultrasonic ranging data, Data(n) is the measured distance of the n-th sampling point in the ultrasonic ranging data, K is a window length parameter of a preset filter window, abs is an absolute value function, and VarDev(n) is the variance deviation of the n-th sampling point in the ultrasonic ranging data; and
instructions for filtering out the sampling points with the variance deviation larger than a preset variance deviation threshold from the ultrasonic ranging data to obtain the filtered ultrasonic ranging data.

18. The robot of claim 13, wherein the measured distance of the target sampling point is output to a robot to navigate the robot based on the measured distance.

19. The robot of claim 15, the computer program further comprises:
outputting an invalid value, in response to the difference being not within the difference interval.
